(19) United States
(12) Patent Application Publication
(10) Pub. No.: US 2018/0119484 A1
(43) Pub. Date: May 3, 2018

(54) DOOR SWEEP AND METHOD FOR INSTALLING A DOOR SWEEP

(71) Applicant: Endura Products, Inc., Colfax, NC (US)

(72) Inventors: Adam Kendall, Burlington, NC (US); Tom Jaskiewicz, Oak Ridge, NC (US)

(21) Appl. No.: 15/796,139

(22) Filed: Oct. 27, 2017

Related U.S. Application Data
(63) Continuation-in-part of application No. 15/338,032, filed on Oct. 28, 2016.

(51) Int. Cl. E06B 7/23

(52) U.S. Cl. CPC E06B 7/2316

(57) ABSTRACT

A door sweep includes a resilient segment, a first segment, with interior and exterior ends, where the interior end connects to the first end of the resilient segment, and a second segment, with interior and exterior ends, where the interior end connects to the second end of the resilient segment. The door sweep also has a first rail engaging lip on a top surface of the first segment adjacent to the exterior end, a second rail engaging lip on a top surface of the second segment adjacent to the exterior end, and a first finger disposed on the exterior end of the first segment. The first and second rail engaging lips are configured to engage first and second offset edges of a rail mounted to a bottom of a door. The first finger is engageable by a tool that to connect the first rail engaging lip to the rail.

### CROSS-REFERENCE TO RELATED APPLICATION(S)

This U.S. patent application is a Continuation-In-Part of U.S. patent application Ser. No. 15/338,032, which was filed on Oct. 28, 2016, the entire contents of which are incorporated herein by reference.

### FIELD OF THE INVENTION

The present disclosure relates to a door sweep. While not limiting of the present invention, an aspect of the disclosure provides for a door sweep configured to attach to a mounting rail mounted at the bottom edge of a swinging door, door panel or the like. The disclosed door sweep offers an improved means for assembly to the mounting rail.

### DESCRIPTION OF THE BACKGROUND AND RELATED ART

There are numerous configurations for door sweeps that have been employed in the prior art.

A typical inswing, side-hinged door system utilizes a flexible sealing member, or door sweep, secured to the bottom edge of the door panel. The door sweep interacts with a cap component of the door sill or a threshold to create a barrier that discourages external elements, such as air, water, dirt, and debris, in an exterior environment from migrating into an interior environment. The exterior environment may be outside of a structure, such as a building or house, for example, while the interior environment may be a room within the structure.

A door sweep often includes dual, protruding fingers that mate with dual slots in the bottom of the door panel. Still further, flexible fins on the fingers may be included to provide a friction fit with the dual slots to retain the door sweep in a desired position on the door panel.

In instances where the door panel does not include slots, other attachments method may include suitable fasteners, such as adhesives, staples, or screws.

Certain door panels used in exterior, side-hinged door assemblies employ a different door sweep design. These door panels have a stamped steel rail with offset edges over which the door sweep slidably engages. The installation of door sweeps for these door panels involves sliding the door sweep from the proximate end of the rail to the distal end of the rail until the leading edge of the door sweep aligns with the distal end of the rail. One disadvantage to this design involves the clearance required for the door sweep to engage the rail. Specifically, a larger clearance results in a less effective seal between the door panel and the rail. Moreover, a considerable amount of force may be needed to slide the door sweep onto the door, complicating the assembly process.

While some solutions to one or more of the difficulties enumerated above have been proposed by the prior art, a need persists for improved solutions.

### SUMMARY OF THE INVENTION

The present invention addresses one or more of the deficiencies with respect to the prior art.

Specifically, the present invention provides a door sweep that allows for easy assembly to the door panel.

Another aspect of the present invention is that the door sweep facilitates an effective barrier to external environmental elements.

The present disclosure provides a door sweep configured to engage a door panel of an exterior, side-hinged door assembly having a stamped steel rail with offset edges. The door sweep is configured with rigid slots that engage with offset edges of the mounting rail. Using an assembly tool, the door sweep may be mounted to the mounting rail.

An embodiment provides a door sweep designed to mate with a door panel mounting rail that allows for easy assembly to the door panel while facilitating an effective barrier to external environmental elements. In this embodiment, opposing, inwardly oriented rigid slots of the door sweep are configured to engage offset edges of a mounting rail. A flexible bulb is co-extruded on the top surface of the sweep to act as a primary seal between the door panel and the door sweep. Co-extruded flexible ribs on the inner faces of the rigid slots mate with the top and bottom surfaces of the offset rail edges to prevent migration of air and water from the exterior to the interior of the building when the door panel is closed, as well as to facilitate retention of the sweep on the rail. Upwardly projecting rigid fingers extend from the base of the door sweep towards the bottom edge of the door panel to maintain a substantially parallel orientation of the base to the bottom of the door panel. The base includes a co-extruded, resilient central segment to allow extension of the base during assembly. The edges of the door sweep include rigid, hooked fingers for receiving a mounting tool.

The resilient sealing members extending from the bottom of the door sweep may embody various configurations that interact with the cap component of the door sill or threshold to create a barrier that can resist infiltration of external elements such as air, water, dirt and debris from the exterior environment into the interior of the building. These elements may be symmetric about the vertical centerline of the door sweep profile to allow for non-oriented attachment.

The mounting of the door sweep to the mounting rail may involve mating one of the rigid slots of the door sweep with one offset edge of the mounting rail substantially along the length of each component. An assembly tool may then be used to grab the hooked finger on the non-engaged edge of the door sweep. Using the face of the door panel as a fulcrum, the tool is rotated towards the top edge of the door panel. This action causes the resilient central segment of the door sweep to extend and allow the second slot of the door sweep to extend past the second offset edge of the mounting rail. As tool rotation continues, the second slot of the door sweep aligns with the second offset edge of the mounting rail. As the tool is released, the resilient central segment of the door sweep contracts and engages the second offset edge of the mounting rail in the second slot of the door sweep. The door sweep is now mounted to the mounting rail.

Among other aspects and features, the present invention provides a door sweep that includes a resilient segment with a first end and a second end, a first segment, with interior and exterior ends, wherein the interior end connects to the first end of the resilient segment, a second segment, with interior and exterior ends, wherein the interior end connects to the second end of the resilient segment, a first rail engaging lip on a top surface of the first segment adjacent to the exterior end, a second rail engaging lip on a top surface of the second segment adjacent to the exterior end, and a first finger disposed on the exterior end of the first segment. The first and second rail engaging lips are configured to engage first and second offset edges of a rail mounted to a bottom of a door. The first finger is engageable by a tool that to connect the first rail engaging lip to the rail.

In one contemplated embodiment, a second finger may be disposed on the exterior of end of the second segment. If so, the second finger is engageable by the tool to connect the second rail engaging lip to the rail.

Still further, the first rail engaging lip may define a first slot that receives the first offset edge of the rail.

Next, it is contemplated that the second rail engaging lip may define a second slot that receives the second offset edge of the rail.

In another contemplated embodiment, the resilient segment, the first segment, and the second segment may define a base with a top surface and a bottom surface. Here, the door sweep may include a sealing member connected to the bottom surface of the base.

The sealing member is contemplated to include at least one sealing fin.

Alternatively, the sealing member may include at least one sealing bulb.

In another variant, the sealing member is contemplated to include at least one sealing fin and at least one sealing bulb.

And, in another embodiment, the sealing member may include a plurality of sealing bulbs and a plurality of sealing fins.

The door sweep of the present invention also may be configured to include a first flexible bulb disposed atop the first segment and a second flexible bulb disposed atop the second segment at the exterior ends thereof to establish a seal with the bottom of the door.

In a further contemplated embodiment, the door sweep includes a first flexible pincer disposed atop the first segment and a second flexible pincer disposed atop the second segment at the exterior ends thereof to establish a seal with the bottom of the door.

Where pincers are provided, the first and second flexible pincers are contemplated to include a first pincer element and a second pincer element, the first and second pincer elements being squeezed together to form a seal when the door sweep is disposed on the bottom of the door.

If pincers are provided, the first pincer may be longer than the second pincer and the first pincer may be disposed closer to a centerline of the door sweep than the second pincer.

For embodiments of the present invention, the resilient member is contemplated to be a resilient material.

Still further, the resilient material may be at least one of flexible polyvinyl chloride, rubber, and flexible polymers.

Next, the first segment and the second segment may be made from a rigid material.

A rigid material may be at least one of rigid polyvinyl chloride, plastic, composites, and metal.

The present invention also provides a method for attaching a door sweep to a door with a rail connected thereto, where the door sweep comprises a resilient segment with a first end and a second end, a first segment, with interior and exterior ends, where the interior end connects to the first end of the resilient segment, a second segment, with interior and exterior ends, where the interior end connects to the second end of the resilient segment, a first rail engaging lip on a top surface of the first segment adjacent to the exterior end defining a first slot, a second rail engaging lip on a top surface of the second segment adjacent to the exterior end defining a second slot, and a first finger disposed on the exterior end of the first segment. The method includes: (a) positioning a second edge of the rail into the second slot, (b) engaging a first edge of a mounting tool into the first finger, (c) engaging a second edge of the mounting tool onto a face of the door, (d) rotating the mounting tool towards a top edge of the door, (e) extending the first rail engaging lip away from the second slot, thereby aligning at least a portion of the first slot with the first edge of the rail, and (f) disengaging the mounting tool from the first finger while maintaining the at least a portion of the first slot with the first edge of the rail.

The method may also include repeating steps (a)-(f) in sequence along a length of the first finger until the door sweep completely engages the rail.

Alternatively, the method may include repeating steps (b)-(f) in sequence along a length of the first finger until the door sweep completely engages the rail.

Further aspects of the present invention will be made apparent from the paragraphs that follow.

### BRIEF DESCRIPTION OF THE DRAWING(S)

The present invention will now be described in connection with the drawings appended hereto, in which:

FIG. 1 is a cross-sectional, graphical illustration of a first embodiment of a door sweep according to the present invention, showing the door sweep mounted to a stamped steel rail at the bottom edge of the door panel and also showing an engagement between an assembly tool and a hooked finger on one end of the door sweep during installation of the door sweep to the rail;

FIG. 2 is an enlarged, cross-sectional, graphical illustration of the door sweep shown in FIG. 1, providing additional details;

FIG. 3 is a cross-sectional, graphical illustration of the juxtaposition of the door sweep illustrated in FIG. 2 with a sill;

FIG. 4 is a cross-sectional, graphical illustration of a second embodiment of a door sweep according to the present invention; and

FIG. 5 is a cross-sectional, graphical illustration of the second embodiment of the door sweep as illustrated in FIG. 4, showing the door sweep mounted to an associated rail.

### DETAILED DESCRIPTION OF EMBODIMENT(S) OF THE INVENTION

The present invention will now be described in connection with one or more embodiments. The discussion of any one particular embodiment is not intended to be limiting of the present invention. To the contrary, any discussion of specific embodiments is intended to exemplify the breadth and scope of the present invention. As should be apparent to those skilled in the art, variations and equivalents of the embodiment(s) described herein may be employed without departing from the scope of the present invention. Those variations and equivalents are intended to be encompassed by the scope of the present patent application.

The content and substance of all patents and other publications identified in the paragraphs that follow are incorporated herein by reference in their entireties, whether or not explicitly stated. In addition, the content and substance of U.S. Non-Provisional patent application Ser. No. 14/717,194 and U.S. Design Patent Application Serial No. 29/527,556 are expressly incorporated herein by reference in their entireties.

Any reference to patents and/or publications herein is provided for the purpose of incorporating into this patent application the subject matter described and disclosed therein. It is contemplated, for example, that the methodologies described in these patents and publications may be used in connection with the present invention. However, any subject matter presented by those patents and publications is not intended to provide definitions of terms inconsistent with those presented herein. All statements as to the date or representation as to the contents of these documents is based on information available to the applicants and do not constitute any admission as to the correctness of the dates or contents of these documents.

As used herein and in the claims, the singular forms “a,” “an,” and “the” include the plural reference unless the context clearly indicates otherwise. Throughout this specification, unless otherwise indicated, “comprise,” “comprises” and “comprising” are used inclusively rather than exclusively, so that a stated integer or group of integers may include one or more other non-stated integers or groups of integers. The term “or” is inclusive unless modified, for example, by “either.” Other than in the operating examples, or where otherwise indicated, all numbers expressing quantities of ingredients or reaction conditions used herein should be understood as modified in all instances by the term “about.”

Unless defined otherwise, all technical and scientific terms used herein have the same meaning as those commonly understood to one of ordinary skill in the art. The terminology used herein is for the purpose of describing particular embodiments only, and is not intended to limit the scope of the present invention, which is defined solely by the claims.

The terms “male” and “female” may be used interchangeably to describe corresponding components or complementary aspects thereof and are not a limitation to either particular structure unless context clearly indicates otherwise.

Headings are provided for convenience only and are not to be construed to limit the invention in any way.

In order that the present disclosure can be more readily understood, certain terms are first defined. Additional definitions are set forth throughout the detailed description.

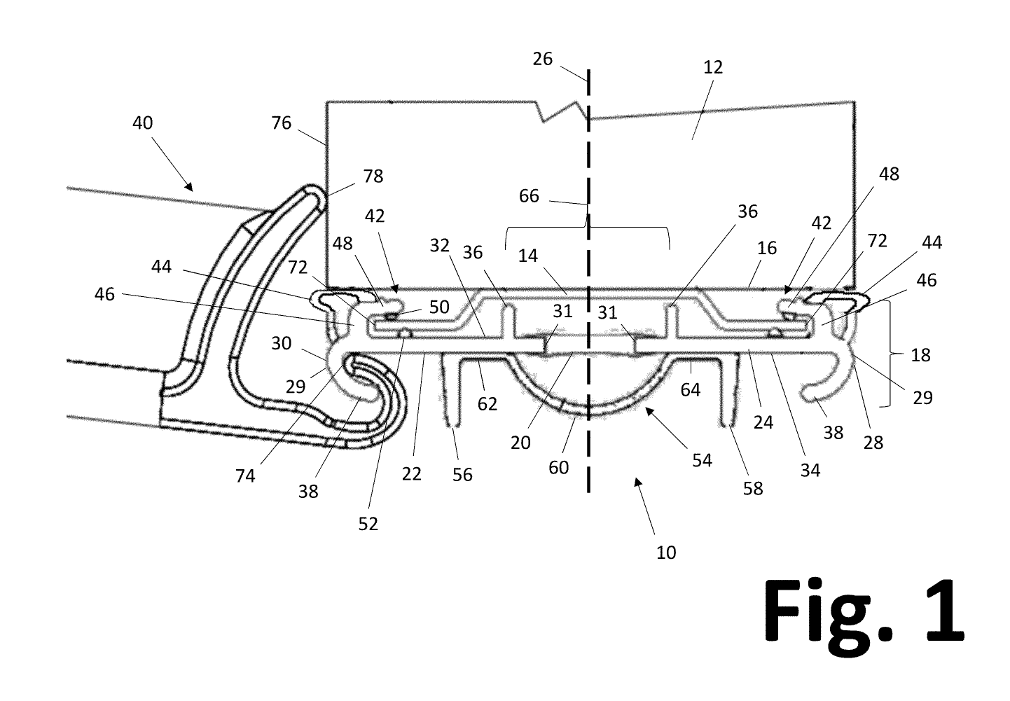

A first embodiment of a door sweep 10 according to the present invention is provided in FIG. 1. The door sweep 10 is connected to a door 12. More specifically, the door sweep 10 connects to a rail 14 that is attached to a bottom surface 16 of the door 12.

The door sweep 10 comprises a base 18. As shown, the base 18 includes a resilient segment 20 that is disposed between a first segment 22 and a second segment 24. The resilient segment 20 is contemplated to assist with the installation of the door sweep 10 onto a door, because the resilient segment 20 permits the base 18 to flex with respect to a centerline 26 of the base 18 when manipulated by a tool 40. Further details concerning the installation of the door sweep 10 to the door 12 are provided below.

As illustrated, the resilient segment 20 defines a centerline 26. The centerline 26 is contemplated to bisect the resilient segment 20, which is symmetrical about the centerline 26. The centerline 26 also is contemplated to coincide with a centerline of the door 12. It is noted, however, that the positioning of the centerline 26 of the base with the centerline of the door 12 is exemplary only. The centerline 26 of the base 18 may be offset from the centerline of the door 12 without departing from the scope of the present invention.

As points of reference, the base 18 defines an interior edge 28 and an exterior edge 30.

The first segment 22 is defined by an exterior end 29 and an interior end 31. Since the second segment 24 is a mirror image of the first segment 22, the second segment 24 also defines the same interior end 31 and the same exterior end 29. Although it is contemplated that the first segment 22 will be constructed as a mirror image of the second segment 24, the first segment 22 may differ in its construction from the second segment 24 without departing from the scope of the present invention.

Since the first segment 22 and the second segment 24 are mirror images of one another, the discussion of features associated with the first segment 22 apply equally to the second segment 24.

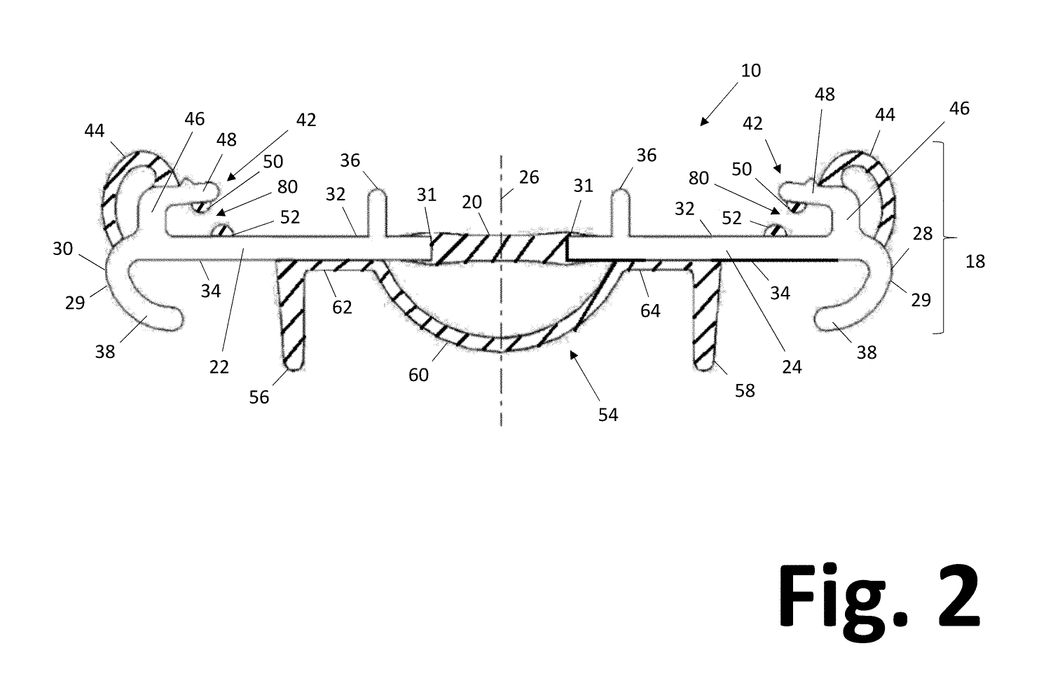

With reference to FIG. 2, the base 18 includes a top surface 32 and a bottom surface 34. The top surface 32 faces toward the bottom surface 16 of the door 12.

An alignment ridge 36 is attached to and extends upwardly from the top surface 32 at a position adjacent to the exterior end 29 of the first segment 22. The alignment ridge 36 is provided to help align the door sweep 10 on the rail 14 attached to the bottom surface 16 of the door 12. The alignment ridge also provides a more stable fit between the rail 14 and the door sweep 10.

The exterior end 29 of the first segment 22 includes a finger 38 extending downwardly with respect to the bottom surface 34. The finger 38 is hook-shaped and may be engaged by the tool 40, which is shown in FIG. 1. When the tool 40 engages the finger 38, the tool 40 pulls on the first segment 22, the position of which is altered as permitted by the degree of flexibility associated with the resilient segment 20.

The top surface 32 of the first segment 22 includes a rail engaging lip 42 and a bulb 44 at the exterior end 29.

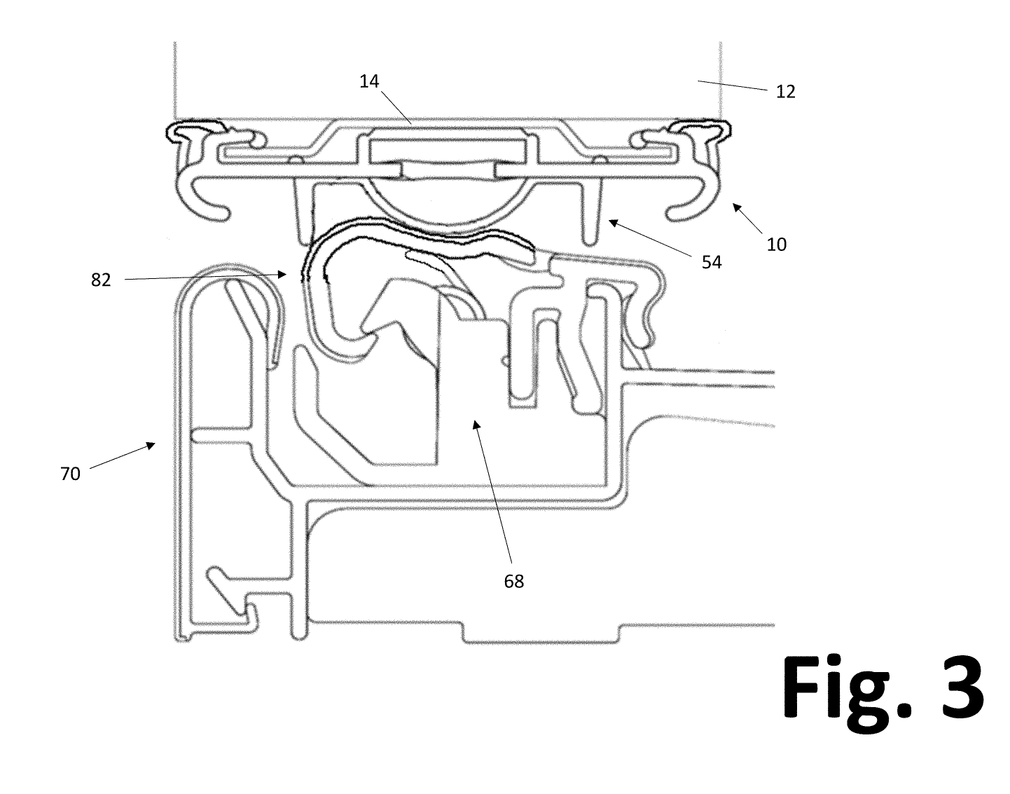

The rail engaging lip 42 is an L-shaped structure having a vertical segment 46 that extends upwardly from the top surface 32. The engaging lip 42 also includes a horizontal segment 48 that extends from the vertical segment 46 toward the interior end 31 and the centerline 26. The rail engaging lip 42 includes a first rib 50 extending downwardly toward the top surface 32 of the first segment 22. The first segment 22 has a second rib 52 extending upwardly from the top surface 32 of the first segment 22 toward the horizontal segment 48. The first rib 50 and the second rib 52 are near to one another, but offset from one another. The positioning of the first rib 50 and the second rib 52 in this manner facilitates an interference fit between the base 18 and the rail 14, specifically the offset edges 72 of the rail 14, as shown in FIGS. 1 and 3.

The bulb 44 extends upwardly from the horizontal segment 48 of the rail engaging lip 42 and connects to the exterior end 29 of the first segment 22. The bulb 44 provides a sealing engagement between the door sweep 10 and the door 12. As illustrated, the bulb 44 forms a compressible, tubular, hollow structure at the exterior end 29 of the first segment 22.

As noted above, the second segment 24 shares the same construction as the first segment 22, except that the second segment 24 is a mirror image of the first segment 22 due to its positioning as a part of the base 18.

A sealing member 54 is attached to the base 18. The sealing member 54 includes a first sealing fin 56, a second sealing fin 58, and a sealing bulb 60. The sealing member 54 also includes a first horizontal segment 62 and a second horizontal segment 64. The first horizontal segment 62 connects the first sealing fin 56 to the central bulb 60. The second horizontal segment 64 connects the second sealing fin 58 to the sealing bulb 60. Collectively, the first sealing fin 56, the second sealing fin 58, and the sealing bulb 60 establish a seal with a sill cap 82 (shown in FIG. 3) when the door 12 is closed. The sealing member 54 helps to discourage ingress of water, dirt, and debris from entering the interior of the structure from the exterior.

It is noted that the construction of the sealing member 54 is exemplary only and is not intended to be limiting of the present invention. It is contemplated that, in its simplest form, the sealing member 54 may include at least one sealing fin 56 or 58. In another contemplated embodiment, the sealing member 54 may include at least one sealing bulb 60. Still further, the sealing member 54 may include at least one fin 56 or 58 and at least one sealing bulb 60. And, as should be apparent to those skilled in the art, the sealing member may include a plurality of sealing fins 56, 58 and a plurality of sealing bulbs 60.

With continued reference to FIG. 2, the resilient segment 20, the bulbs 44, and the sealing member 54 are illustrated with a cross-shading. This cross-shading is intended to convey that these elements of the present invention are contemplated to be made from resilient materials. By contrast, the first segment 22 and the second segment 24 are contemplated to be manufactured from rigid materials, which include semi-rigid materials as should be apparent to those skilled in the art. Resilient materials include, but are not limited to, flexible polyvinyl chloride, rubber, flexible polymers, and the like. Rigid materials include, but are not limited to, rigid polyvinyl chloride, plastics, composites, metals, and the like.

Renewed reference is now made to FIG. 1. As indicated above, a tool 40 may be employed to assist with installing the door sweep 10 onto the rail 14 attached to the bottom surface 16 of the door 12. As should be apparent from the illustration, when the tool 40 engages the finger 38 on the door sweep 10, the application of leverage by a user causes the door sweep 10 to flex. As noted above, the degree of flexure depends, at least in part, on the flexibility of the resilient segment 20.

With the assistance of the tool 40, it becomes possible to engage a portion of the rail engaging lip 42 onto the rail 14 for at least a portion of the door 12. The tool 40 may then be moved along the width of the door 12, repeating the attachment operation, until the entire length of the rail engaging lip 42 engages the entire length of the rail 14.

To install the door sweep 10 onto the rail 14, a user first mates a first one of the rail engaging lips 42 to the offset edge 72 of the rail 14. The first edge 74 of the tool 40 is placed into the finger 38 on the non-engaged edge of the door sweep 10. Using the face 76 of the door 12 as a fulcrum, the second edge 78 of the tool 40 is placed against the face 76 of the door 12. The tool 40 is rotated towards the top edge (not shown) of the door 12. This action causes the central, resilient segment 20 of the door sweep 10 to extend and/or flex, allowing the second one of the rail engaging lips 42 to extend past the second offset edge 72 of the rail 14. As the user continues to rotate the tool 40, the second rail engaging lip 42 aligns with the second offset edge 72. Upon release of the tool 40, the central, resilient segment 20 contracts, causing the second rail engaging lip 42 to engage the second rail edge 72 in the slot 80. This procedure may be repeated, as necessary, along the length of the rail 14. In this manner, the door sweep 10 mates to the rail 14.

The rail 14 is contemplated to be made from a rigid material. As such, without limiting the composition of the rail 14, the rail 14 may be made from rigid polyvinyl chloride, plastics, composites, metals, and the like. In the illustrated embodiment, the rail 14 is constructed from stamped steel.

The distance between the alignment ridges 36 also is referred to as a mounting slot 66. For the door sweep 10, there is only one mounting slot 66. However, a plurality of mounting slots 66 may be provided without departing from the scope of the present invention.

The door sweep 10 also includes two rail engaging lips 42. While this is contemplated to be sufficient for the door sweep 10, it is contemplated that the door sweep 10 might include a larger number of rail engaging lips 42 without departing from the scope of the present invention.

Next, the door sweep 10 includes two fingers 38. While this construction is contemplated to be typical, it is possible that the door sweep 10 might include a larger number of fingers 38 without departing for the scope of the present invention.

The first sealing fin 56, the second sealing fin 58, and the sealing bulb 60 that are a part of the sealing member 54 extend from the bottom of the door sweep 10. The illustrated configuration of the sealing member 54, however, may be altered without departing from the scope of the present invention. Any of a number of configurations for the sealing member 54 are contemplated to interact with a cap component 68 of a door sill 70 or threshold to create a barrier that resists infiltration of external elements, such as air, water, dirt and debris, from the exterior environment into the interior of the building. These configurations may embody various size, shape and quantities.

As should be apparent, the door sweep 10 is symmetric about the centerline 26. Being symmetric, the construction of the door sweep 10 allows for non-oriented attachment. In other words, the door sweep 10 may be installed such that the interior edge 28 and the exterior edge 30 are reversed. However, symmetry is not required to practice the present invention, as noted above.

As shown in FIG. 2, and as indicated above, the rail engaging lips 42 establish slots 80 that receive the offset edges 72 of the rail 14. The first rib 50 and the second rib 52 help to hold the door sweep 10 on the rail 14 by engaging each offset edge 72. The first rib 50 and the second rib 52 are contemplated to be made from a flexible material. While not limiting the present invention, the flexible material may be flexible polyvinyl chloride, rubber, flexible polymers, and the like. The first and second ribs 50, 52 engage and mate with the offset edges 72 of the rail 14 to prevent migration of air or water from the exterior to the interior of a building when the door 12 is closed.

The flexible bulbs 44 also are contemplated to be co-extruded onto the top surface of the door sweep 10 to act as a primary seal between the door sweep 10 and the door 12. The ribs 50, 52 also are contemplated to be co-extruded with the first segment 22 and the second segment 24.

The alignment ridges 36 project upwardly from the base 18 and extend toward the rail 14. As noted above, the alignment ridges 36 act as spacers to keep the base 18 relatively parallel to the bottom surface 16 of the door 12.

The sealing member 54 is contemplated to be co-extruded with the base 18. The sealing member 54 mates with the door sill 70, sill cap 82, or another associated, threshold cap component to ensure a weather seal at this intersection.

The door sweep 10 is contemplated to be an extrusion where both the flexible and rigid materials are co-extruded. For this reason, it is contemplated that flexible polyvinyl chloride and rigid polyvinyl chloride will be used for flexible and rigid elements of the door sweep 10. As noted, however, other materials may be employed without departing from the scope of the present invention.

FIG. 3 provides a graphical side view of the door sweep 10 as it might appear when engaging a door sill 70 to establish a seal between the door 12 and the door sill 70 when the door 12 is closed. The door sill 70 is contemplated to be mounted on a floor of the house, building or structure in which the door sweep 10 is employed. When the door 12 is closed, the resilient member 54 of the door sweep 10 engages a sill cap 82 of the sill 70. This ensures a weather seal between the floor and the door sweep 10.

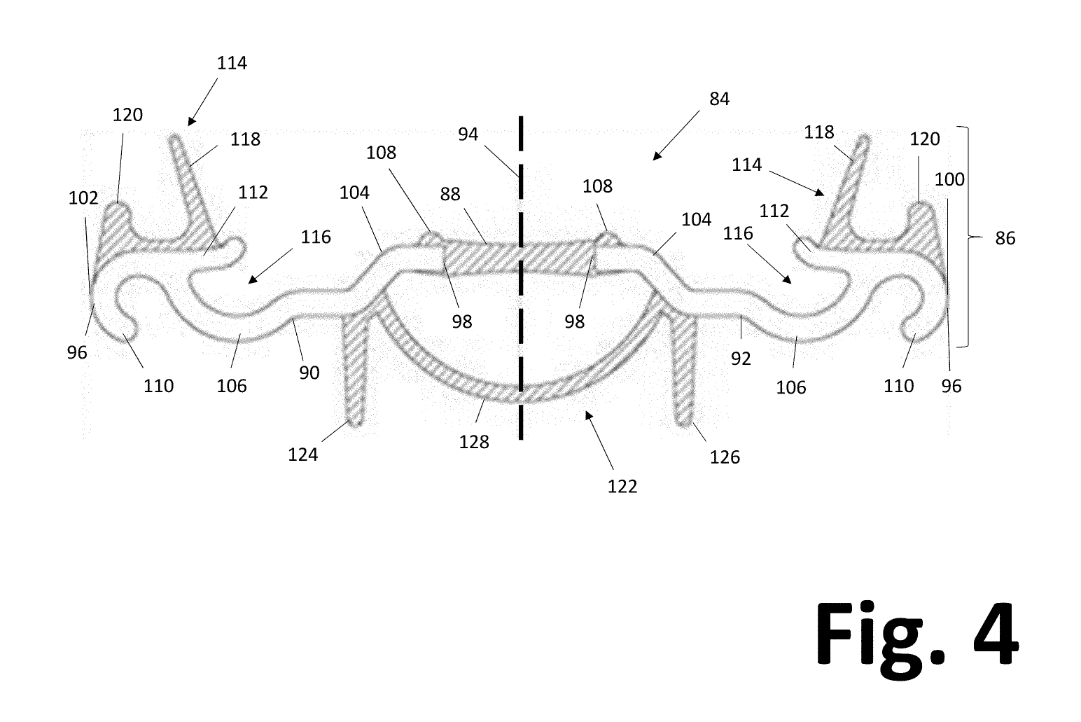

FIG. 4 is a graphical, cross-sectional side view of a second embodiment of a door sweep 84 according to the present invention. Despite differences in its appearance and construction, the door sweep 84 shares many of the same features as the door sweep 10.

The door sweep 84 includes a base 86 that combines a resilient segment 88, a first segment 90, and a second segment 92. As with the door sweep 10, the resilient segment 88 is made from a resilient material and connects the first segment 90 to the second segment 92. The first and second segments 90, 92 are contemplated to be made from rigid or semi-rigid materials, the details of which are provided in connection with the discussion of the door sweep 10. The resilient segment 88 permits the door sweep 84 to flex with respect to a centerline 94 when the door sweep 84 is manipulated by the tool 40 in the manner described above.

As in the prior embodiment, the centerline 94 bisects the door sweep 84, which is symmetrical about the centerline 94. Similarly, the first segment 90 and the second segment 92 are mirror images of one another. As such, the first and second segments 90, 92 define exterior ends 96 and interior ends 98. As before, the door sweep 84 defines an interior edge 102 and an exterior edge 100. Although it is contemplated that the first segment 90 will be constructed as a mirror image of the second segment 92, the first segment 90 may differ in its construction from the second segment 92 without departing from the scope of the present invention.

Since the first segment 90 and the second segment 92 are mirror images of one another, the discussion of features associated with the first segment 90 apply equally to the second segment 92.

With reference to FIG. 4, the base 86 includes a top surface 104 and a bottom surface 106. The top surface 104 faces toward the bottom surface 16 of the door 12. An alignment ridge 108 is attached to and extends upwardly from the top surface 104 at a position adjacent to the exterior end 96 of the first segment 90. The alignment ridge 108 is provided to help align the door sweep 84 on the rail 14 attached to the bottom surface 16 of the door 12. The alignment ridge 108 provides a more stable fit between the rail 14 and the door sweep 84.

The exterior end 96 of the first segment 90 includes a finger 110 extending downwardly with respect to the bottom surface 106. The finger 110 is hook-shaped and is provided to engage the tool 40, which is shown in FIG. 1. When the tool 40 engages the finger 110, the tool 40 pulls on the first segment 90, the position of which is altered as permitted by the degree of flexibility associated with the resilient segment 88.

The top surface 104 of the first segment 90 defines a rail engaging lip 112 and a pincer 114 at the exterior end 96.

The rail engaging lip 112 is disposed apart from the top surface 104 due to the shape of the first segment 90. The rail engaging lip 112 establishes a slot 116 that accommodates an offset edge 72 of the rail 14.

The pincer 114 includes a first pincer element 118 and a second pincer element 120. The first pincer element 118 is longer than the second pincer element 120. The first pincer element 118 also is disposed at a position closer to the centerline 94 than the second pincer element 120. When installed on the door 12, the first pincer element 118 is squeezed into engagement with the second pincer element 120, thereby establishing a suitable seal between the door sweep 84 and the door 12.

As noted above, the second segment 92 shares the same construction as the first segment 90, except that the second segment 92 is a mirror image of the first segment 90 due to its positioning as a part of the base 86.

A sealing member 122 is attached to the base 86. The sealing member 122 includes a first sealing fin 124, a second sealing fin 126, and a sealing bulb 128. Collectively, the first sealing fin 124, the second sealing fin 126, and the sealing bulb 128 establish a seal with a sill cap 82, such as the one shown in FIG. 3, when the door 12 is closed. The sealing member 122 helps to discourage ingress of water, dirt, and debris from entering the interior of the structure from the exterior.

As with the sealing member 54, however, the construction of the sealing member 122 is intended to be a non-limiting example. The sealing member 122 may include at least one sealing fin 124 or 126. In another contemplated embodiment, the sealing member 122 may include at least one sealing bulb 128. Still further, the sealing member 122 may include at least one fin 124 or 126 and at least one sealing bulb 128. And, as should be apparent to those skilled in the art, the sealing member may include a plurality of sealing fins 124, 126 and a plurality of sealing bulbs 128.

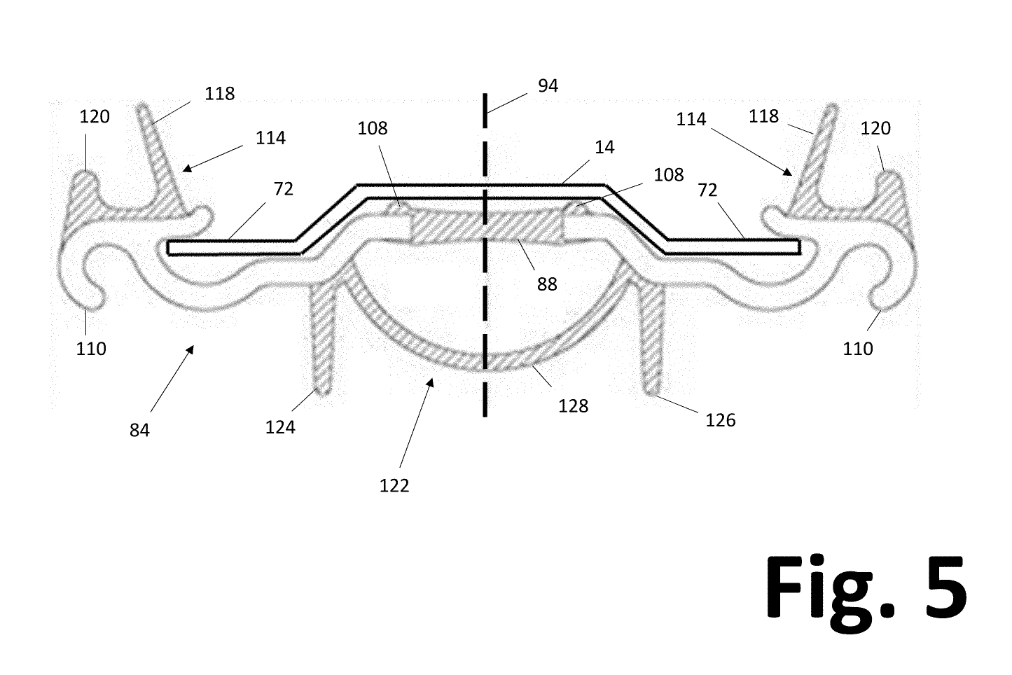

With reference to FIGS. 4 and 5, the resilient segment 88, the pincers 114, and the sealing member 122 are illustrated with a cross-shading. This cross-shading is intended to convey that these elements of the present invention are contemplated to be made from resilient materials. By contrast, the first segment 90 and the second segment 92 are contemplated to be manufactured from rigid materials, which include semi-rigid materials as should be apparent to those skilled in the art. Resilient materials include, but are not limited to, flexible polyvinyl chloride, rubber, flexible polymers, and the like. Rigid materials include, but are not limited to, rigid polyvinyl chloride, plastics, composites, metals, and the like.

The door sweep 84 is contemplated to be installed on the rail 14 in the same manner as described in connection with the door sweep 10. The tool 40 is contemplated to be used in the manner discussed above.

In particular, the method includes: (a) positioning a second edge 72 of the rail 14 into the second slot 116, (b) engaging a first edge 74 of a mounting tool 40 into the first finger 110, (c) engaging a second edge 78 of the mounting tool 40 onto a face of the door 12, (d) rotating the mounting tool 40 towards a top edge of the door 12, (e) extending the first rail engaging lip 112 away from the second slot 116, thereby aligning at least a portion of the first slot 116 with the first edge 72 of the rail 12, and (f) disengaging the mounting tool 40 from the first finger 110 while maintaining the at least a portion of the first slot 116 with the first edge 72 of the rail 14. Steps (a)-(f) may be repeated in sequence along a length of the first finger 110 until the door sweep 84 completely engages the rail 14. Alternatively, the method may include repeating steps (b)-(f) in sequence along a length of the first finger 110 until the door sweep 84 completely engages the rail 14.

It should be understood that the examples and embodiments described herein are for illustrative purposes only and that various modifications or changes in light thereof will be suggested to persons skilled in the art and are to be included within the spirit and purview of this application and the scope of the appended claims. All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

As noted above, the embodiment(s) described herein are intended to be exemplary of the wide breadth of the present invention. Variations and equivalents of the described embodiment(s) are intended to be encompassed by the present invention, as if described herein.

What is claimed is:

1. A door sweep, comprising:
a resilient segment with a first end and a second end;
a first segment, with interior and exterior ends, wherein the interior end connects to the first end of the resilient segment;
a second segment, with interior and exterior ends, wherein the interior end connects to the second end of the resilient segment;
a first rail engaging lip on a top surface of the first segment adjacent to the exterior end;
a second rail engaging lip on a top surface of the second segment adjacent to the exterior end; and
a first finger disposed on the exterior end of the first segment,
wherein the first and second rail engaging lips are configured to engage first and second offset edges of a rail mounted to a bottom of a door, and
wherein the first finger is engageable by a tool that to connect the first rail engaging lip to the rail.

2. The door sweep of claim 1, further comprising a second finger disposed on the exterior of end of the second segment, wherein the second finger is engageable by the tool to connect the second rail engaging lip to the rail.

3. The door sweep of claim 1, wherein the first rail engaging lip defines a first slot that receives the first offset edge of the rail.

4. The door sweep of claim 3, wherein the second rail engaging lip defines a second slot that receives the second offset edge of the rail.

5. The door sweep of claim 1, wherein the resilient segment, the first segment, and the second segment define a base with a top surface and a bottom surface, the door sweep further comprising:
a sealing member connected to the bottom surface of the base.

6. The door sweep of claim 5, wherein the sealing member comprises:
at least one sealing fin.

7. The door sweep of claim 5, wherein the sealing member comprises:
at least one sealing bulb.

8. The door sweep of claim 6, wherein the sealing member further comprises:
at least one sealing bulb.

9. The door sweep of claim 5, wherein the sealing member comprises:
a plurality of sealing bulbs; and
a plurality of sealing fins.

10. The door sweep of claim 1, further comprising:
a first flexible bulb disposed atop the first segment and a second flexible bulb disposed atop the second segment at the exterior ends thereof to establish a seal with the bottom of the door.

11. The door sweep of claim 1, further comprising:
a first flexible pincer disposed atop the first segment and a second flexible pincer disposed atop the second segment at the exterior ends thereof to establish a seal with the bottom of the door.

12. The door sweep of claim 11, wherein the first and second flexible pincers comprise:
a first pincer element and a second pincer element, the first and second pincer elements being squeezed together to form a seal when the door sweep is disposed on the bottom of the door.

13. The door sweep of claim 12, wherein the first pincer is longer than the second pincer and the first pincer is disposed closer to a centerline of the door sweep than the second pincer.

14. The door sweep of claim 1, wherein the resilient member comprises a resilient material.

15. The door sweep of claim 14, wherein the resilient material is at least one of flexible polyvinyl chloride, rubber, and flexible polymers.

16. The door sweep of claim 1, wherein the first segment and the second segment are made from a rigid material.

17. The door sweep of claim 16, wherein a rigid material is at least one of rigid polyvinyl chloride, plastic, composites, and metal.

18. A method for attaching a door sweep to a door with a rail connected thereto, wherein the door sweep comprises a resilient segment with a first end and a second end, a first segment, with interior and exterior ends, wherein the interior end connects to the first end of the resilient segment, a second segment, with interior and exterior ends, wherein the interior end connects to the second end of the resilient segment, a first rail engaging lip on a top surface of the first segment adjacent to the exterior end defining a first slot, a second rail engaging lip on a top surface of the second segment adjacent to the exterior end defining a second slot, and a first finger disposed on the exterior end of the first segment, the method comprising:
(a) positioning a second edge of the rail into the second slot;
(b) engaging a first edge of a mounting tool into the first finger;
(c) engaging a second edge of the mounting tool onto a face of the door;
(d) rotating the mounting tool towards a top edge of the door;
(e) extending the first rail engaging lip away from the second slot, thereby aligning at least a portion of the first slot with the first edge of the rail; and
(f) disengaging the mounting tool from the first finger while maintaining the at least a portion of the first slot with the first edge of the rail.

19. The method of claim 18, further comprising:
repeating steps (a)-(f) in sequence along a length of the first finger until the door sweep completely engages the rail.

20. The method of claim 18, further comprising:
repeating steps (b)-(f) in sequence along a length of the first finger until the door sweep completely engages the rail.
